(19) United States
(12) Patent Application Publication
(10) Pub. No.: US 2004/0135005 A1
(43) Pub. Date: Jul. 15, 2004

(54) Fluid dispenser

(75) Inventor: Frederic Duquet, Thibouville (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS

(21) Appl. No.: 10/743,026

(22) Filed: Dec. 23, 2003

Related U.S. Application Data
(60) Provisional application No. 60/459,618, filed on Apr. 3, 2003.

(30) Foreign Application Priority Data
Dec. 23, 2002 (FR) FR-02/16545

(51) Int. Cl. B05B 9/00; B65D 1/32; B05B 11/04; B01D 17/00

(52) U.S. Cl. 239/326; 239/327; 239/328

(57) ABSTRACT

A fluid dispenser for dispensing a fluid in the form of a powder, said fluid dispenser comprising a fluid reservoir (23) provided with a movable actuating wall (22) and with a spraying orifice (53), the reservoir containing a piece of porous material (4) suitable for being impregnated with gas and with the fluid in powder form, said fluid dispenser being characterized in that the porous material occupies the major part of the volume of the reservoir.

### CROSS REFERENCE TO RELATED APPLICATION

This application claims the benefit under 35 U.S.C. §119(e) of pending U.S. provisional patent application Serial No. 60/459,618, filed Apr. 3, 2003, and priority under 35 U.S.C. §119(a)-(d) of French patent application No. FR-02.16545, filed Dec. 23, 2002.

### TECHNICAL FIELD OF THE INVENTION

The present invention relates to a fluid dispenser for dispensing a fluid in the form of a powder, said dispenser comprising a fluid reservoir provided with a movable actuating wall and with a spraying orifice. The term “powder” designates any solid in the form of fine particles and that has mechanical and dynamic qualities of a liquid, i.e. it flows, can be sprayed, fills volumes etc. The present invention is more particularly applicable to the fields of perfumes, of cosmetics, or indeed of pharmaceuticals.

### BACKROUND OF THE INVENTION

In order to actuate the dispenser, it is necessary merely to exert pressure on the movable actuating wall, thereby reducing the working volume of the reservoir and putting the powder that it contains under pressure. Under the effect of such pressure, the powder is driven towards the spraying orifice, beyond which it is dispensed in the form of a jet of sprayed fluid. It is advantageous for the reservoir to contain a gas, e.g. air, which serves as an entrainment medium for conveying the powder towards the spraying orifice and beyond in the form of a spray.

To guarantee continuous and substantially constant dispensing at the outlet of the spraying orifice, it is necessary for the proportion of powder relative to gas to be substantially constant. Unfortunately, the powder can move inside the reservoir or build up on one side or the other distant from or in the vicinity of the spraying orifice. Thus, as a function of the location of the powder inside the reservoir, the extent to which the jet of sprayed fluid is laden with powder varies.

In the prior art, US-2002/0190081 describes a deformable actuating wall dispenser comprising a reservoir containing a fluid product, which may be of a powder type. The reservoir also contains a piece of porous material suitable for being impregnated with fluid product. This piece of porous material occupies a minor part of the volume of the reservoir, so that the powder may gather inside the reservoir outside the piece of porous material. This results in an non-constant spraying.

### SUMMARY OF THE INVENTION

An object of the present invention is to solve that problem related to non-constant spraying at the outlet of the spraying orifice.

To achieve this object, the present invention provides a fluid dispenser for dispensing a fluid in the form of a powder, said fluid dispenser comprising a fluid reservoir provided with a movable actuating wall and with a spraying orifice, the reservoir containing a piece of porous material suitable for being impregnated with gas and with the fluid in powder form, said fluid dispenser being characterized in that the porous material occupies the major part of the volume of the reservoir. Thus, the powder is distributed in the cells in almost uniform manner three-dimensionally inside the reservoir. Any build-up of powder at a particular place in the reservoir is thus avoided. In addition, the piece of porous material acts as a baffle for the gas and for the powder that is carried by the gas. The open cells of the piece of porous material constitute channels for transporting the powder conveyed by the gas under pressure. Unlike a fluid in liquid form which soaks the piece of porous material by capillary action, the fluid in powder form is supported by the inside walls of the open cells making up the piece of porous material, thereby preventing it from building up under gravity. The fluid in powder form is not sensitive to capillary action. The piece of porous material is thus not used as a soaking-up sponge, but rather as a support for supporting the fine component particles of the powder in uniform manner through almost the entire reservoir so as to form uniform three-dimensional distribution. The piece of porous material thus serves as a stepped support for the powder which is subjected to gravity.

Advantageously, the piece of porous material extends to the vicinity of the spraying orifice. In a variant, the piece of porous material may be separated from the spraying orifice by a mixing chamber.

According to another characteristic, the piece of porous material is elastically deformable.

Advantageously, the piece of porous material extends under the actuating wall so as to be deformed while the actuating wall is moving. In which case, the piece of porous material may resiliently urge the actuating wall of the reservoir into a rest position.

According to another characteristic of the invention, the piece of porous material occupies substantially the entire volume of the reservoir. In a variant, the piece of porous material occupies more than half, advantageously 60%, and preferably 75% of the volume of the reservoir.

According to another characteristic of the invention, substantially all of the fluid in powder form in the reservoir impregnates and lies inside the piece of porous material.

### BRIEF DESCRIPTION OF THE DRAWING

The invention is described more fully below with reference to the accompanying drawings which give an embodiment of the invention by way of non-limiting example.

In the figures:

FIG. 1 is a plan view of a fluid dispenser of the invention;

FIG. 2 is a vertical section view through the dispenser of FIG. 1; and

FIG. 3 is an enlarged view of the front portion of the dispenser of FIG. 2.

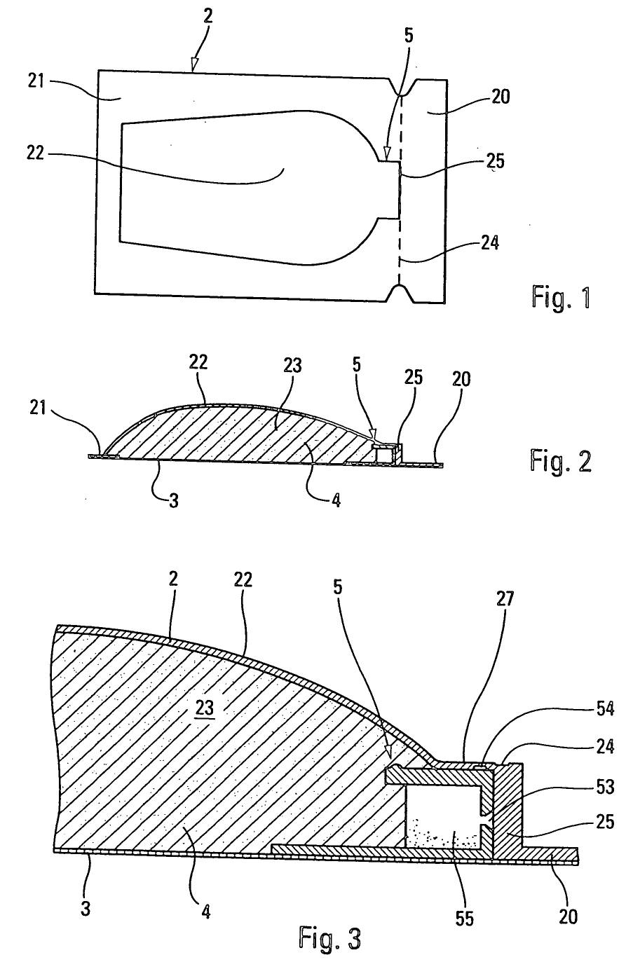

### DETAILED DESCRIPTION OF THE INVENTION

The powder dispenser shown in the figures is made up of four component elements, namely a shaped sheet 2, a sealing bottom sheet 3, a piece of porous material 4, and an end-piece 5. It is optionally possible to omit the end-piece 5. The shaped sheet 2 forms a plane peripheral margin 21 and a central portion in relief that is substantially dome-shaped. The sealing bottom sheet 3 is connected in leaktight manner to the shaped sheet 2 at the plane peripheral margin 21 so as to isolate the volume formed at the central portion in relief. Most of the resulting volume serves as a reservoir for the powder 23. Naturally, it is possible to make a fluid reservoir in a totally different manner, without using sheets sealed together. For example, the reservoir may be made up of a receptacle having flexible walls. The receptacle having flexible walls may be in the form of a small flask made of a compressible material, or else in the form of a flexible pouch made up of freely deformable sheets. The structure of the reservoir is not critical for the present invention. But in the example used to illustrate the present invention and shown in the figures, the dispenser is made up of two sheets sealed together to form a powder reservoir between them.

According to a characteristic of the invention, the dispensing orifice is not formed by the sheets 2 or 3, but rather by the end-piece 5 which is disposed between the two sheets 2 and 3, as can be seen more clearly in FIG. 3. For example, the sheets 2 and 3 may be fixed by sealing to the end-piece 5. It can be seen in FIG. 3 that the shaped sheet 2 is fixed to the end-piece 5 at a portion 27. Advantageously, the end-piece 5 may be provided with sealing ribs 54 serving to melt at least in part to improve the cohesion between the shaped sheet 2 and the end-piece 5. The end-piece 5 thus forms a spraying orifice 53 which communicates with the reservoir designated overall by numerical reference 23. In a non-limiting embodiment, a mixing chamber 55 is disposed immediately upstream from the spraying orifice 53.

In the invention, the fluid reservoir 23 contains a piece of porous material 4 suitable for being impregnated with fluid in powder form. Advantageously, almost all or all of the fluid impregnates and lies inside the piece of porous of material 4. When a mixing chamber 55 is provided, as it is in FIGS. 2 and 3, it is possible that a small quantity of powder might be present in the mixing chamber. In practice, the mixing chamber 55 separates the piece of porous material 4 from the spraying orifice 53. The mixing chamber 55 makes it possible for swirling to be generated, such swirling being conducive to conveying the powder through the spraying orifice 53. The piece of porous material 4, which is impregnated with powder, also contains gas, e.g. air. Advantageously, the proportion of gas contained inside the piece of porous material 4 is significantly larger than the quantity of powder. The piece of porous material 4 is of the open-cell type, i.e. it is made up of a maze of intertwined channels that communicate with one another so that the piece is permeable 4 in through manner. When the piece of porous material 4 is only lightly laden with powder, the open cells are not blocked, which makes it possible for the stream of gas to pass through the cells, thereby entraining the powder towards the spraying orifice 53.

The portion in relief formed by the shaped sheet 2 advantageously forms a moveable actuating wall 22. In this example, the actuating wall is moved by deformation, by exerting pushing-in pressure, e.g. by means of the thumb of the hand. Thus, by pushing in the actuating wall 22, the internal volume of the reservoir 23 is reduced, thereby putting the gas contained in the reservoir under pressure. As a result, the gas is driven towards the spraying orifice 53 while carrying with it a fraction of the powder. It is advantageous for the actuating wall 22 to have a shape memory enabling it to return to its rest position defining the maximum volume for the reservoir. This position is as shown in FIG. 2. In order to enable the actuating wall to return to its rest position, resilient return spring means are necessary. The resilient return means may be formed directly by the actuating wall 22. For example, it is necessary merely to impart to it a shape and resilience such that it returns by itself automatically into its rest position as soon as the pushing-in pressure ceases. In a variant, it is also possible to make provision for the resilient return means to be generated by the piece of porous material 4 situated inside the reservoir 23. In which case, it is not even necessary to use a specially shaped sheet, e.g. of the thermoformed type. It is possible merely to use a flexible sheet which is shaped by the presence of the piece of porous material 4 inside the reservoir 23. In which case, the actuating wall 22 is returned to its rest position entirely by the elasticity of the piece of porous material 4 which is situated immediately below the actuating wall. The dispenser can then be constituted merely by a piece of elastically deformable porous material included inside a deformable flexible pouch exempt from any intrinsic shape memory. The end-piece 5 may even be omitted. In which case, the spraying orifice is formed directly at one of the two sheets or between the sheets.

The piece of porous material 4 may occupy the entire volume of the reservoir 23 and extend into direct contact with the spraying orifice 53. In a variant, the piece of porous material may occupy a smaller proportion of the reservoir, e.g. one half of the reservoir, 60% of the reservoir, or even 75% of the reservoir. In any case, the piece of porous material preferably occupies the major part of the volume of the reservoir.

In the example used to illustrate the invention, and prior to use, the spraying orifice 53 is closed off by a removable closure element 20 which is constituted by the shaped sheet 2 and by the sealing sheet 3 as sealed together. The closure member 20 can be separated from the remainder of the dispenser along a score line 24 that passes immediately in front of the end piece 5 at which the member 20 forms a closure wall 25 facing the spraying orifice 53. Thus, prior to use, the reservoir 23 is fully isolated from the outside. It is even possible to make provision for the piece of porous material 4 to be compressed to a state close to its maximum compressed state so long as the removable closure member is in place to close off the spraying orifice 53. In which case, it is only at the time the removable closure member 20 is removed that the piece of porous material 4 can expand by air being taken into the reservoir through the spraying orifice 53. The dispenser can thus have a configuration that is particularly flat or compressed before the removable closure member 20 is removed. Such a piece of elastically deformable porous material may be also be used in a liquid dispenser for the purpose of imparting a resilient return function to the movable actuating wall so as to enable it to be returned to its rest position.

1/ A fluid dispenser for dispensing a fluid in the form of a powder, said fluid dispenser comprising a fluid reservoir (23) provided with a movable actuating wall (22) and with a spraying orifice (53), the reservoir containing a piece of porous material (4) suitable for being impregnated with gas and with the fluid in powder form, said fluid dispenser being characterized in that the porous material occupies the major part of the volume of the reservoir.

2/ A dispenser according to claim 1, in which the piece of porous material (4) extends to the vicinity of the spraying orifice (53).

3/ A dispenser according to claim 1, in which the piece of porous material (4) is elastically deformable.

4/ A dispenser according to claim 1, in which the piece of porous material (4) extends under the actuating wall (22) so as to be deformed while the actuating wall is moving.

5/ A dispenser according to claim 1, in which the piece of porous material (4) occupies substantially the entire volume of the reservoir.

6/ A dispenser according to claim 1, in which the piece of porous material (4) occupies more than half, advantageously 60%, and preferably 75% of the volume of the reservoir.

7/ A dispenser according to claim 3, in which the piece of porous material (4) resiliently urges the actuating wall (22) of the reservoir into a rest position.

8/ A dispenser according to a claim 1, in which the piece of porous material (4) is separated from the spraying orifice (53) by a mixing chamber (55).

9/ A dispenser according to claim 1, in which substantially all of the fluid in powder form in the reservoir impregnates and lies inside the piece of porous material (4).

10/ A dispenser according to claim 1, in which the piece of porous material is of the open-cell type, the powder being supported inside the cells in substantially uniform manner throughout the piece of porous material.
